(19) United States
(12) Patent Application Publication
(10) Pub. No.: US 2017/0162193 A1
(43) Pub. Date: Jun. 8, 2017

(54) BROWSER OPERATION METHOD AND ELECTRONIC DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Shaopeng YU, Tianjin (CN)

(21) Appl. No.: 15/249,304

(22) Filed: Aug. 26, 2016

Related U.S. Application Data
(63) Continuation of application No. PCT/CN2016/089076, filed on Jul. 7, 2016.

(30) Foreign Application Priority Data
Dec. 4, 2015 (CN) 201510889796.5

(51) Int. Cl. G10L 15/18; G10L 15/10

(52) U.S. Cl. CPC G10L 15/1822; G10L 15/10; G10L 2015/223

(57) ABSTRACT

Disclosed are a browser operation method and electronic device. The method comprises acquiring and parsing voice data from a microphone of the smart TV when a current interface of the smart TV is an operating interface of the browser, matching the parsed voice data and a preset voice command in the browser, and executing browser operation, which corresponds to the voice command matched with the parsed voice data. In the embodiment of the present disclosure, an operating command is transmitted by voice of a user, the condition that the browser is operated by using a remote control of the smart TV is avoided, and the operating speed is improved.

### CROSS-REFERENCE TO RELATED APPLICATIONS

The present disclosure is a continuation of International Application No. PCT/CN2016/089076 filed on Jul. 7, 206, which is based upon and claims priority to Chinese Patent Application No. 201510889796.5, entitled “BROWSER OPERATION METHOD OF SMART TV AND SMART TV”, filed Dec. 4, 2015, and the entire contents of all of which are incorporated herein by reference.

### TECHNICAL FIELD

The disclosure generally relates to the technical field of televisions and in particular to a browser operation method of a smart TV and the smart TV.

### BACKGROUND

Nowadays, more and more intelligent hardware products are coming into view of the public, and the smart TV serving as a family entertainment center is gradually taken as a necessary living room product. Compared with the traditional TV, the smart TV can acquire more network resources, richer contents and more special applications. At present, a problem wherein a remote control is too complicated to control commonly exists in a browser of the smart TV, and a convenient control mode is in urgent need.

According to the existing browser on the smart TV, functions such as character input, return, refresh, fast forward, fast backward, etc. in the browser need to be realized through corresponding keys on the remote control of the smart TV. Partial functions of the browser need many key operations, even some operations can be finished by clicking the remote control several times or more than ten times, and the operation steps are very complicated.

### SUMMARY

The present invention discloses a browser operation method of a smart TV and the smart TV, used for solving the problem that the operating steps of the browser of the existing smart TV are complicated.

According to a first aspect, the present invention provides a browser operation method of a smart TV including:

acquiring and parsing voice data from a microphone of the smart TV when a current interface of the smart TV is an operating interface of the browser;

matching the parsed voice data and a preset voice command in the browser;

and executing browser operation which corresponds to the voice command matched with the parsed voice data.

According to a second aspect, the present invention provides an electronic device, including: at least one processor; and a memory communicably connected with the at least one processor for storing instructions executable by the at least one processor, wherein execution of the instructions by the at least one processor causes the at least one processor to:

acquire and parse voice data from a microphone of the smart TV when a current interface of the smart TV is an operating interface of the browser;

match the parsed voice data and a preset voice command in the browser;

execute browser operation which corresponds to the voice command matched with the parsed voice data.

According to a third aspect, the present invention provides a non-volatile computer readable storage medium, where the non-volatile computer readable storage medium stores a computer instruction, and a computer executes the computer instruction to execute the following operations: acquire and parse voice data from a microphone of an electronic device when a current interface of the electronic device is an operating interface of the browser; match the parsed voice data and a preset voice command in the browser; execute browser operation which corresponds to the voice command matched with the parsed voice data.

According to the browser operation method and electronic device provided by the embodiment of the present disclosure, an operating command is transmitted by the voice of a user, specifically the voice of the user is received by a microphone of the smart TV and is parsed, the parsed voice is matched with at least one preset voice command in the browser. If the match is successful, an operation, which corresponds to the voice command matched with the parsed voice aiming at the browser, is executed, the condition that the browser is operated by using a remote control of the smart TV is avoided, and the operating speed is improved.

### BRIEF DESCRIPTION OF THE DRAWINGS

To clearly describe the technical schemes in the embodiments of the present disclosure, figures needing to be used in the description of the embodiments are briefly introduced as follows, obviously, the figures described below are some embodiments of the present disclosure, and for a person skilled in the art, other figures can be also obtained according to the figures under the condition that no creative work is made.

FIG. 1 shows the flow chart of steps of the browser operation method of the smart TV in the embodiment I of the present disclosure.

FIG. 2 shows the structure diagram of the smart TV in the embodiment II of the present disclosure.

FIG. 3 schematically shows a block diagram of an electronic device used for executing the method according to the present disclosure.

FIG. 4 schematically shows a storage unit used for keeping or carrying program codes realizing the method according to the present disclosure.

### DETAILED DESCRIPTION

To make the purposes, technical schemes and advantages of the embodiments of the present disclosure clearer, the technical schemes in the embodiments of the present disclosure are clearly and completely described with the following figures in the embodiments of the present disclosure, the described embodiments are not all but a part of the embodiments of the present disclosure. Based on the embodiments of the present disclosure, other embodiments obtained by a person skilled in the art under the condition that no creative work is made all belong to the protection scope of the present disclosure.

### Embodiment I

The browser operation method of the smart TV provided in the embodiment I of the present disclosure is introduced in details and is applied to the smart TV.

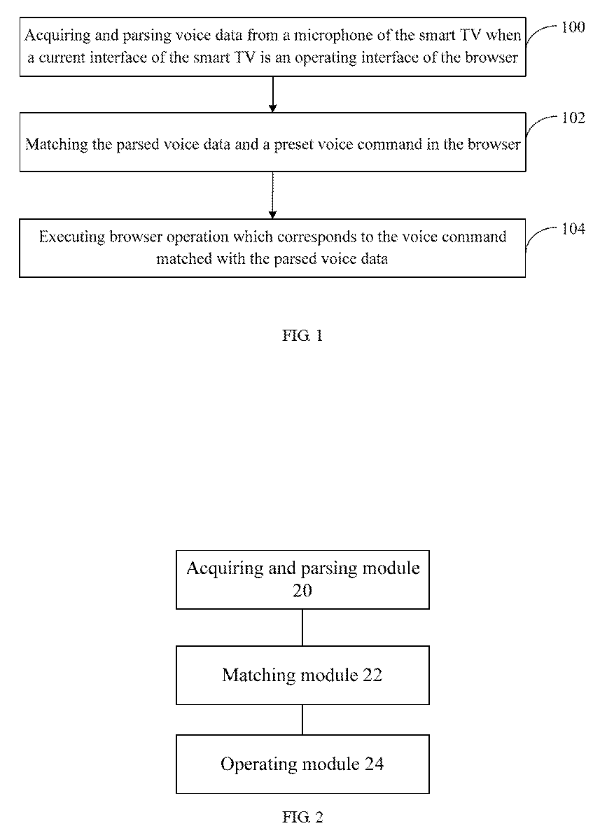

FIG. 1 shows the flow chart of the steps of the browser operation method of the smart TV in the embodiment I of the present disclosure.

Step 100, acquiring and parsing voice data from a microphone of the smart TV when a current interface of the smart TV is an operating interface of the browser.

When the current interface of the smart TV is the operating interface of the browser, the current operating object is the browser.

The step of acquiring the voice data from the microphone of the smart TV specifically refers to an operation of acquiring the voice data through a data capture callback function OnsoundDataIn (Sound sound, boolean isUserGesture).

In a preferred embodiment of the present disclosure, after the voice data from the microphone of the smart TV is acquired, whether the voice data is the voice of a user can be determined and, when the voice data is the voice of the user, an operation of parsing the voice data is executed. The specific process of determining whether the voice data is the voice of the user can be: determining whether boolean isUserGesture in the data capture callback function is true or false. If true, the voice data is the voice of the user; if false, the voice data is not the voice of the user and is possibly voice transmitted by the smart TV or the generated echo.

The specific process of determining whether the voice data is the voice of the user can determine whether frequency of the voice data is between 120 and 700 Hz, if between 120 and 700 Hz, the voice data can be determined as the voice of the user.

Whether the voice data is the voice of the user is further determined, and error browser operation generated by environmental noise can be avoided.

After the voice data is acquired, the acquired voice data can be parsed, specifically: performing character recognition on the voice data, and converting the voice data into character strings.

Step 102, matching the parsed voice data and a preset voice command in the browser.

The voice command is preset in the browser and stored in a voice command list of the browser, shown as table 1.

TABLE 1

| Default command | |
|---|---|
| characters | Specific operations |
| I want to visit | Inputting webpage address |
| Determine | According to browser's status, including the following several |
| | conditions: |
| | 1. When currently inputting website in browser address bar, |
| | jumping to the website. |
| | 2. When currently inputting other data, ending input. If the next |
| | input field exists, jumping to the next input field for inputting |
| | 3. If the currently controlled is a simulated mouse, performing |
| | click operation of the simulated mouse |
| Input | Searching other text input fields in the browser except the |
| | address bar, and inputting |
| Refresh | Refreshing the current webpage |
| Fast Backward | Returning to the visited webpage before if a visit webpage exists |
| | before the current webpage |
| Fast Forward | Returning to the webpage before if the current webpage is |
| | displayed by another webpage through the backward operation |
| Clear Input | Clearing the current input characters |
| Close | Closing the current tabs, and returning to exit from the browser |
| | if only one tab exists at present |
| Exit | Exiting from the browser |
| Open history | Opening history of the browser |
| Open favorites | Opening favorites of the browser |
| Up | Controlling simulated mouse to move up |
| Down | Controlling simulated mouse to move down |
| Left | Controlling simulated mouse to move to left |
| Right | Controlling simulated mouse to move to right |

Moreover, the voice command is a definable voice command and can be automatically set by the user, and the specific operation is constant.

The step 102 specifically can be completely matching the character strings and the preset voice command in the browser according to a sequence, wherein, the sequence can be a top-down sequence. The aim of completely matching is to avoid the condition of error operations.

Step 104, executing the browser operation which corresponds to the voice command matched with the parsed voice data.

If the parsed voice data is completely matched with a certain voice command in the browser, the matching operation is stopped, and a specific operation that corresponds to the matched voice command is executed. For example, if the certain parsed voice data is “fast forward”, a specific operation that corresponds to the voice command “fast forward” is executed.

In conclusion, according to the technical scheme in the embodiment of the present disclosure, the operating command is transmitted by the voice of the user, specifically the voice of the user is received by the microphone of the smart TV and is parsed, and the parsed voice is matched with at least one preset voice command in the browser. If the match is successful, an operation that corresponds to the voice command matched with the parsed voice aiming at the browser is executed, the condition that the browser is operated by using a remote control of the smart TV is avoided, and the operating speed is improved.

### Embodiment II

The smart TV provided in the embodiment II of the present disclosure is introduced in details.

FIG. 2 shows the structure diagram of the smart TV in the embodiment II of the present disclosure.

The smart TV can include an acquiring and parsing module 20, a matching module 22 and an operating module 24.

The functions of each module and relations among the modules are respectively introduced in detailed in the followings.

The acquiring and parsing module 20 is used for acquiring and parsing voice data from a microphone of the smart TV when a current interface of the smart TV is an operating interface of the browser.

In a preferred embodiment of the present disclosure, the smart TV also can include:

a determining module, used for determining whether the voice data is voice of a user after the acquiring and parsing module 20 acquires the voice data from the microphone of the smart TV; and when the voice data is the voice of the user, the acquiring and parsing module 20 executes an operation of parsing the voice data.

Preferably, the acquiring and parsing module 20 parses the voice data from the microphone of the smart TV, specifically the acquiring and parsing module 20 converts the voice data into character strings.

The matching module 22 is used for matching the parsed voice data and a preset voice command in the browser, wherein the voice command is stored in a voice command list of the browser and is a definable voice command.

Preferably, the matching module 22 performs complete matching on the character strings and the preset voice command in the browser according to a sequence.

The operating module 24 is used for executing browser operation that corresponds to the voice command matched with the parsed voice data.

In conclusion, according to the technical scheme in the embodiment of the present disclosure, the operating command is transmitted by the voice of the user, specifically the voice of the user is received by the microphone of the smart TV and is parsed, and the parsed voice is matched with at least one preset voice command in the browser. If the match is successful, an operation that corresponds to the voice command matched with the parsed voice aiming at the browser is executed, the condition that the browser is operated by using a remote control of the smart TV is avoided, and the operating speed is improved.

The embodiments of the smart TV described above are only schematic, a unit which can be described as a separated part can be or not physically separated, a member for unit display can be or not a physical unit, that is, the member can be located at one place or distributed to multiple network units. A part of or all modules can be selected to achieve the purposes of the schemes of the embodiments according to practical demands. The present disclosure can be understood and implemented by a person skilled in the art without creative work.

In addition, it should be noted that, although in the above illustration a smart TV is taken as an example, in practical application, the present disclosure may also be applied to various electronic devices, which is not limited to be smart TV.

According to description of the embodiments above, a person skilled in the art can clearly know that each embodiment can be realized in a manner of software plus necessary general hardware platform and can be realized by virtue of hardware certainly. Based on the understanding, the technical scheme or a part making contribution to the prior art can be essentially reflected in a software product form, and the computer software products can be stored in computer readable media, such as ROM/RAM, disks, compact discs, etc., and include a plurality of instructions to be used for enabling computer equipment (also can be a personal computer, a server or network equipment, etc.) to execute the method in each embodiment or in a certain part of the embodiment.

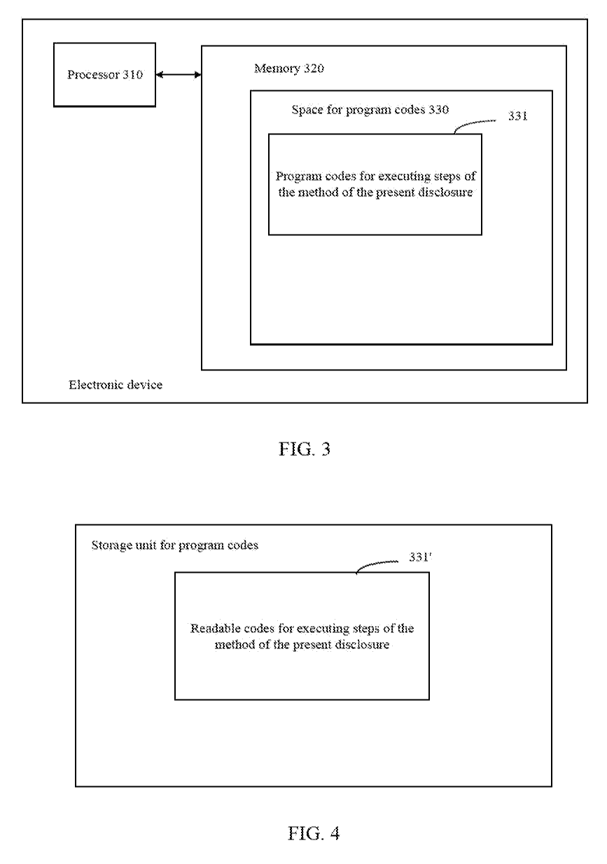

For example, FIG. 3 illustrates a block diagram of an electronic device for executing the method according the disclosure, the electronic device may be the smart TV above. Traditionally, the electronic device includes a processor 310 and a computer program product or a computer readable medium in form of a memory 320. The memory 320 could be electronic memories such as flash memory, EEPROM (Electrically Erasable Programmable Read-Only Memory), EPROM, hard disk or ROM. The memory 320 has a memory space 330 for executing program codes 331 of any steps in the above methods. For example, the memory space 330 for program codes may include respective program codes 331 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 4. The memory cells may be provided with memory sections, memory spaces, etc., similar to the memory 320 of the electronic device as shown in FIG. 3. The program codes may be compressed for example in an appropriate form. Usually, the memory cell includes computer readable codes 331′ which can be read for example by processors 310. When these codes are operated on the electronic device, the electronic device may execute respective steps in the method as described above.

The final description is that the embodiments are only used for describing the technical scheme of the present disclosure but not for limiting. Although the present disclosure is specifically described with reference to the embodiments, a person skilled in the art shall understand that the technical scheme recorded by each of the embodiments can be modified, or one part of technical characteristics can be equivalently replaced; and the modification or replacement does not enable the essence of the corresponding technical scheme to get out of the spirit and scope of the technical scheme in each embodiment of the present disclosure.

What is claimed is:

1. A browser operation method of a smart TV, comprising:
acquiring and parsing voice data from a microphone of the smart TV when a current interface of the smart TV is an operating interface of the browser;
matching the parsed voice data and a preset voice command in the browser;
and executing browser operation which corresponds to the voice command matched with the parsed voice data.

2. The method according to the claim 1, wherein after acquiring the voice data from the microphone of the smart TV, the method also comprises:
determining whether the voice data is voice of a user;
and executing an operation of parsing the voice data when the voice data is the voice of the user.

3. The method according to the claim 1, wherein parsing the voice data from the microphone of the smart TV comprises:
converting the voice data into character strings.

4. The method according to the claim 3, wherein the step of matching the parsed voice data and the preset voice command in the browser comprises:
completely matching the character strings and the preset voice command in the browser according to a sequence.

5. The method according to the claim 1, wherein the voice command is stored in a voice command list of the browser and refers to a definable voice command.

6. An electronic device, comprising:
at least one processor; and
a memory communicably connected with the at least one processor for storing instructions executable by the at least one processor, wherein execution of the instructions by the at least one processor causes the at least one processor to:
acquire and parse voice data from a microphone of the electronic device when a current interface of the electronic device is an operating interface of the browser;
match the parsed voice data and a preset voice command in the browser;
execute browser operation which corresponds to the voice command matched with the parsed voice data.

7. The electronic device according to the claim 6, wherein execution of the instructions by the at least one processor causes the at least one processor to further:
determine whether the voice data is voice of a user after acquiring the voice data from the microphone of the electronic device;
and when the voice data is the voice of the user, execute an operation of parsing the voice data.

8. The electronic device according to the claim 6, wherein parse the voice data from the microphone of the electronic device comprises convert the voice data into character strings.

9. The electronic device according to the claim 8, wherein match the parsed voice data and a preset voice command in the browser comprises completely match the character strings and the preset voice command in the browser according to a sequence.

10. The electronic device according to the claim 6, wherein the voice command is stored in a voice command list of the browser and refers to a definable voice command.

11. A non-transitory computer readable medium storing executable instructions that, when executed by an electronic device, cause the electronic device to:
acquire and parsing voice data from a microphone of the electronic device when a current interface of the electronic device is an operating interface of the browser;
match the parsed voice data and a preset voice command in the browser;
execute browser operation which corresponds to the voice command matched with the parsed voice data.

12. The non-transitory computer readable medium according to the claim 11, wherein the electronic is further caused to:
determine whether the voice data is voice of a user after acquiring the voice data from the microphone of the electronic device; and
when the voice data is the voice of the user, execute an operation of parsing the voice data.

13. The non-transitory computer readable medium according to the claim 11, wherein parse the voice data from the microphone of the electronic device comprises converting the voice data into character strings.

14. The non-transitory computer readable medium according to the claim 13, wherein match the parsed voice data and a preset voice command in the browser comprises completely matching the character strings and the preset voice command in the browser according to a sequence.

15. The non-transitory computer readable medium according to the claim 13, wherein the voice command is stored in a voice command list of the browser and refers to a definable voice command.
